(19) United States
(12) Patent Application Publication
(10) Pub. No.: US 2004/0034441 A1
(43) Pub. Date: Feb. 19, 2004

(54) System and method for creating an index of audio tracks

(76) Inventors: Malcolm Eaton, Chicago, IL (US); Joe Born, Lincolnwood, IL (US)

Correspondence Address: Pennie & Edmonds, LLP, 3300 Hillview Avenue, Palo Alto, CA, 94304, US

(21) Appl. No.: 10/222,462

(22) Filed: Aug. 16, 2002

(51) Int. Cl. G06F 17/00

(52) U.S. Cl. 700/94

(57) ABSTRACT

According to the invention there is provided a method for creating an audio index. It is firstly determined that a computer disc contains at least one audio track. Subsequently, audio identification data associated with the at least one audio track is obtained using digital fingerprinting. An index is thereafter created, where the index is based on the audio identification data. To obtain the audio identification data a sample of the at least one audio track is recorded and transmitted to a remote identification server for identification using digital fingerprinting. The audio identification data is thereafter received from the remote identification server. The remote server identifies the at least one audio track based on the sample.

### BACKGROUND OF THE INVENTION

1. Field of the Invention

The invention relates generally to a system and method for creating an index of audio tracks. More particularly, the invention is directed to a system and method for identifying audio tracks on a computer disc, and thereafter populating a compact disc label with a list of the identified audio tracks.

2. Description of Related Art

Not until the advent of magnetic tape, did users have the ability to easily make personal copies of their music recordings. In particular the recordable compact audio cassette allowed users to easily reproduce, mix, or create compilations of commercial recordings, such as phonograph records. However, such reproductions, mixes, or compilations were recorded in analog, which has many associated disadvantages, such as that subsequent generations of recorded audio recordings show marked deterioration.

With the introduction of the personal computer, users could easily copy digital files onto magnetic media, such as hard drives, portable floppy disks, or the like. Analog audio could now be converted into digital form and be stored on the personal computer as uncompressed digital audio files. However, because of the large size of such uncompressed digital audio files, users could not easily copy these files onto portable media, such as floppy disks, or the like.

The introduction of the compact disc (CD) in the early nineteen eighties allowed multiple large digital audio files to be recorded once onto a CD. Later, in the early nineteen nineties, the introduction of recordable compact disc technology allowed consumers to easily record or “burn” audio tracks onto recordable compact discs (CD-R) or rewritable compact discs (CD-RW), using CD recording software (otherwise known as authoring or “burning” software). In addition, audio extraction software (otherwise known as “ripping” software) allows users to extract raw audio data from a commercial CD, such as a prerecorded music CD, and store the extracted raw audio data in a compressed audio format in an audio file, such as in an MP3 file. This compressed audio file can then be recorded or “burned” onto another CD. These compressed audio files have much smaller files sizes, thereby allowing them to be easily downloaded and/or swapped over the Internet. Consequently, a user's hard-drive may hold multiple compressed audio tracks from a variety of sources, such as audio tracks the user him/herself has extracted from a commercial CD, downloaded audio tracks, compressed or uncompressed audio tracks, etc.

Therefore, due to the proliferation of recordable CD drives, the multitude of sources of audio tracks, and the easy storage of compressed audio files, users now have the ability to easily create compilation CDs from many different sources, albums, and artists.

However, one problem users face once a CD has been recorded, is that they typically have no way of telling what audio tracks are on the CD, other than by audibly identifying each track. To address this problem, many currently available software applications also label recorded discs. These software applications print labels, sleeves, or liners, listing the recorded CD's audio tracks.

One such software application allows users to print a CD label immediately after a CD has been recorded. MUSICMATCH's BURNER PLUS software includes this functionality. For example, once a CD has been recorded and the audio files that were used to create the CD are still selected in the CD authoring software, a user can print a label that is populated with a list of audio identification data associated with the files that were selected to be recorded. Such audio identification data is associated with many types of digital audio files. For example, ID3 tags are associated with MP3 audio files. This audio identification data typically contains basic information about the audio track embodied in the audio file, such as song title, artist, track length, etc.

However, this type of CD labeling software suffers from a number of drawbacks. For example, such CD labeling software only works in conjunction with CD authoring software; such CD labeling software only works at the time the CD is recorded; labels or lists of audio tracks created using such CD labeling software are only as accurate or complete as each audio file's associated audio identification data; such software typically requires additional user intervention, often calling for the user to select from a narrowed down list of choices of audio identification data associated with each audio file; etc.

The audio identification data associated with each audio file is typically originally obtained and associated with the audio file when the audio file is extracted from a commercial CD to a compressed form. At that time, the extraction or “ripping” software typically utilizes a CD identification service, such as FreeDB or CDDB (CD database from GRACENOTE), which obtains the audio identification data for each audio track on the commercial CD, via the Internet. For example, to obtain audio identification data, a user inserts a commercial CD into the computer's CD drive. Client software on the computer uses the number of tracks, the total length of the CD, and the length and sequence of each audio track (obtained from the CD's table of contents) to obtain a unique CD identifier for the commercial CD. Using this unique CD identifier, the client software queries a remote database coupled to the Internet, which returns audio identification data for the commercial CD to the client software. Such audio identification data typically includes the artist, CD-title, and tracklist.

Some current CD authoring software utilizes such CD identification services to populate a list of audio tracks for a particular commercial CD being reproduced. In use, when a user initiates reproducing a commercial CD, the software uses the commercial CD that is being copied to obtain audio identification data for each audio track copied. Such audio identification data is then used to populate a CD label. Examples of such software, include MUSICMATCH's BURNER PLUS software, and ROXIO's EASY CD CREATOR.

The above described software, however, has a number of drawbacks. For example, the CD identification services can only obtain audio identification data if a commercial CD, that includes the audio tracks, can be accessed by the software. Also, if a user does not associate the audio identification data with each audio track at the time of extraction, the audio identification data for that audio track will be lost. Further, a CD identification service cannot be used to identify audio tracks obtained from sources other than a commercial CD, such as if the user downloads a single track from a music subscription service, or the like. Still further, once a compilation or mixed CD has been recorded, the CDDB service is no longer able to identify the audio tracks on the compilation or mixed CD. In addition, identification of data files are not addressed by any of the above solutions.

Therefore, none of the above described solutions provides an effective means for identifying and indexing audio tracks on a computer disc. In light of the above, there is a need for an audio identification device and method that addresses the abovementioned drawbacks, while being convenient and easy to use.

### BRIEF SUMMARY OF THE INVENTION

According to the invention there is provided a method for creating an audio index.

It is firstly determined that a computer disc contains at least one audio track. Subsequently, audio identification data associated with the at least one audio track is obtained using digital fingerprinting. An index is thereafter created, where the index is based on the audio identification data.

To obtain the audio identification data a sample of the at least one audio track is recorded and transmitted to a remote identification server for identification using digital fingerprinting. The audio identification data is thereafter received from the remote identification server. The remote server identifies the at least one audio track based on the sample.

Alternatively, to obtain the audio identification data, a sample of the at least one audio track is recorded. Thereafter a unique digital fingerprint of the at least one audio track is created using the sample. The digital fingerprint is then transmitted to a remote identification server for identification using digital fingerprinting. Subsequently, the audio identification data is received from the remote identification server based on the digital fingerprint.

In yet another embodiment, to obtain the audio identification data, a sample of the at least one audio track is recorded. Thereafter a unique digital fingerprint of the at least one audio track is created using the sample. A local database is then searched for a match to the digital fingerprint. Finally, the audio identification data based on the digital fingerprint, is received.

Further according to the invention there is provided a system for creating an audio index. The system comprises a client computer coupled to a printer and a network. Also coupled to the network are an identification server and a fingerprint provider. The client computer preferably comprises a central processing unit, communication circuitry, a disc drive, and a memory. The memory preferably included identifying and indexing procedures for: determining that a computer disc contains at least one audio track; obtaining audio identification data associated with the at least one audio track using digital fingerprinting; and creating an index based on the audio identification data. The printer is preferably coupled to the client computer, and is configured to print a computer disc label of the index. Furthermore, the identification server is preferably configured to supply the audio identification data by performing digital fingerprinting of audio tracks contained on the computer disc. Also, the fingerprint provider is preferably configured to supply fingerprints of known audio tracks to the identification server.

In a preferred embodiment, once the method for creating an index of audio tracks has been invoked on a computer and a CD inserted into the CD drive of the computer, the method intelligently recognizes the contents of the CD, whether that be audio or data, through a combination of techniques, such as smart file name extraction, audio identification data extraction, playlist importing, and/or digital fingerprinting. The user is then presented with an index, which can be edited and thereafter printed onto a label.

By providing such a method that is not tied to particular recording software, the invention allows an index to be created any time after a disc has been recorded. Indeed, it is inconsequential where or how the disc was created. Accordingly, by combining the functionality of labeling software with intelligent content recognition, the entire method of labeling a disc having unidentified audio tracks thereon, can be automated with the least amount of user intervention and error.

In addition, the above described system and method can provide a central database cataloging burned CDs so that those CDs, complete with labels, can be easily reproduced if lost or scratched. Also, the data from burned CDs can be compiled for marketing purposes, etc. What is more, the above described system and method can be used with a user's current music playing software, thereby reducing the need for superfluous data entry.

### BRIEF DESCRIPTION OF THE DRAWINGS

For a better understanding of the nature and objects of the invention, reference should be made to the following detailed description, taken in conjunction with the accompanying drawings, in which:

FIG. 1 is a diagrammatic view of a system for identifying and indexing audio tracks, according to an embodiment of the invention;

FIG. 2 is a block diagram of the client computer shown in FIG. 1;

FIGS. 3A and 3B are a flow chart of a method for identifying and indexing audio tracks, according to an embodiment of the invention;

FIG. 4 is a flow chart of a method for performing fingerprinting, according to an embodiment of the invention;

FIG. 5 is a flow chart of another method for performing fingerprinting, according to another embodiment of the invention; and

FIG. 6 is a flow chart of yet another method for performing fingerprinting, according to yet another embodiment of the invention.

Like reference numerals refer to corresponding parts throughout the several views of the drawings.

### DETAILED DESCRIPTION OF THE INVENTION

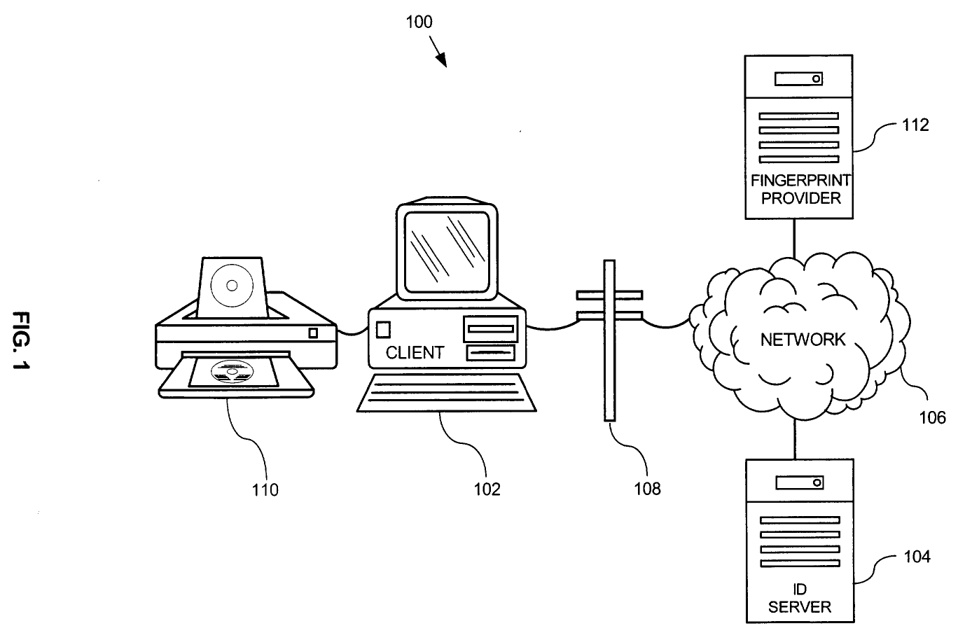

FIG. 1 is a block diagram of a system 100 for identifying and indexing audio, according to an embodiment of the invention. The system 100 comprises at least one client computer 102 and at least one identification server 104 (ID server), coupled to one another via a network 106. The client computer 102 and ID server 104 are any type of computing devices. However, in a preferred embodiment the client computer 102 is a desktop computer, the ID server 104 is a remote server, and the network 106 is the Internet.

The client computer 102 is coupled to the network 106 by any suitable communication link 108, such as Ethernet, coaxial cables, copper telephone lines, optical fibers, wireless, infra-red, or the like. A printer 110 is preferably coupled to the client computer 102. The printer 110 is for printing an index of identified audio tracks. The printer 110 couples to the client computer 102 by any suitable communication link 108, such as via a serial connection, parallel connection, Universal Serial Bus (USB) connection, Firewire connection, Ethernet connection, coaxial cable, copper telephone line, optical fiber, wireless connection, infra-red connection, or the like.

A fingerprint provider 112 is also preferably coupled to the network 106. The fingerprint provider 112 is a server that supplies updated fingerprint data for new audio tracks to the ID server 104.

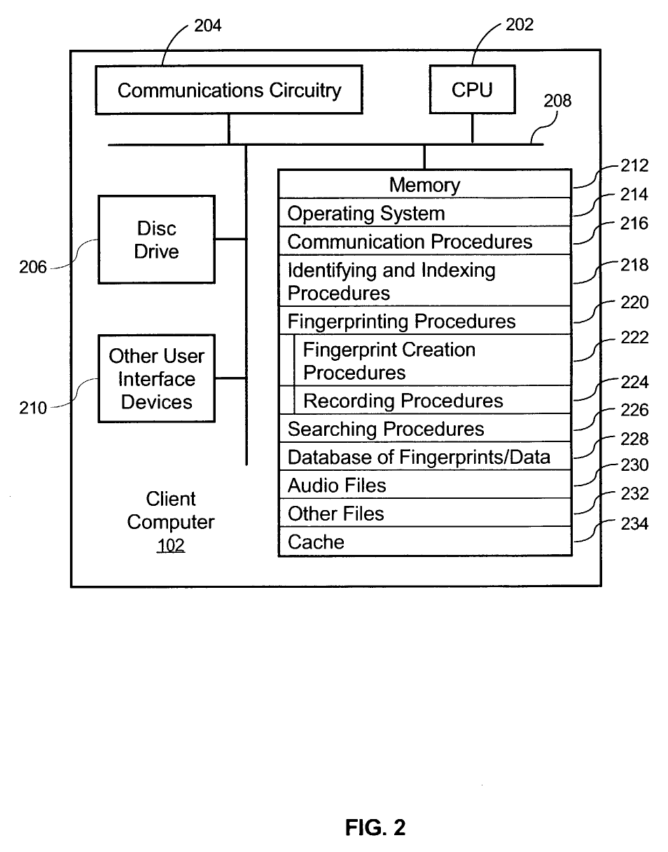

FIG. 2 is a block diagram of the client computer 102 shown in FIG. 1. The client computer 102 preferably includes the following components: at least one data processor or central processing unit (CPU) 202; a memory 212; a disc drive 206, such as a CD-ROM, CD-R, CD-RW, or DVD drive; user interface devices 210, such as a monitor and keyboard; communications circuitry 204 for communicating with the network 106 (FIG. 1), ID server 104 (FIG. 1), and/or printer 110 (FIG. 1); and at least one bus 208 that interconnects these components.

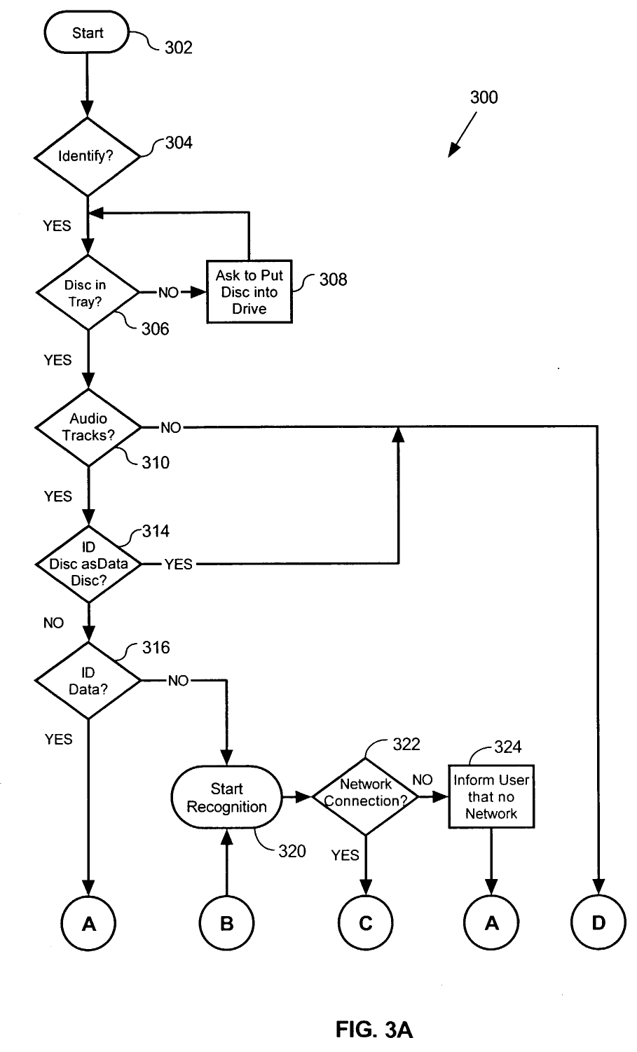

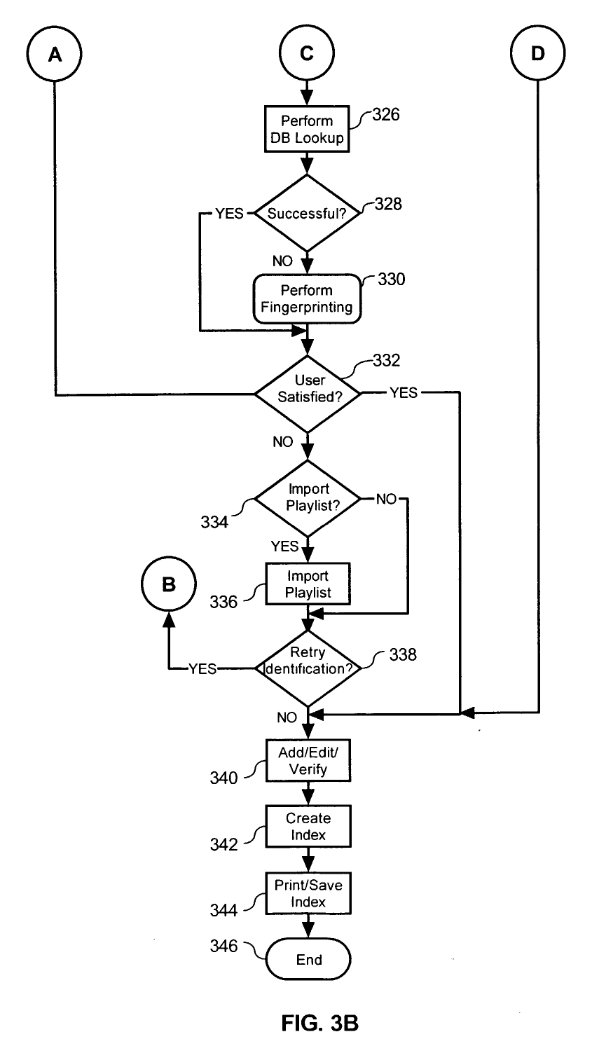

Memory 212 preferably includes an operating system 214, such as WINDOWS, having instructions for processing, accessing, storing, or searching data, etc Memory 212 also preferably includes communications procedures 216 for communicating with the network 106 (FIG. 1), ID server 104 (FIG. 1), and/or printer 110 (FIG. 1); identifying and indexing procedures 218, the function of which is described below in relation to FIGS. 3A-6; fingerprinting procedures 220, the function of which is also described below in relation to FIGS. 3A-6; searching procedures 226, the function of which is described below in relation to FIGS. 3A-6; a database of fingerprints and associated audio identification data 228; audio files 230; other files 232; and a cache 234 for temporarily storing data.

The fingerprinting procedures 220 include fingerprint creation procedures 222 that are used to create a unique identifier or fingerprint for an audio sample of an audio track. The fingerprinting procedures 220 also include recording procedures 224 for recording the audio sample, as described in further detail below in relation to FIGS. 3A-6.

The searching procedures 226 are used for searching the database of fingerprints and audio identification data 228 and for searching the memory 212 for audio files 230, as described in further detail below in relation to FIGS. 3A-6. In one embodiment, the database of fingerprints and audio identification data 228 includes numerous fingerprints of known audio samples or audio tracks and their associated audio identification data, such as song title, artist, or the like.

Whenever a user desires to identify and index a list of music tracks on a disc (or disk) the user invokes the identifying and indexing procedures 218 on the client computer 102 (FIG. 1). By “disc” it is meant any type of portable direct access storage device, such as an optical disc (like a Compact Disc (CD), CD-R, CD-RW, CD-ROM, or Digital Video Disc (DVD)), a magnetic disk (like a floppy disk), or the like. The identifying and indexing procedures 218, in turn, perform the methods set out in FIGS. 3A-6, as described in detail below. It should, however, be appreciated that the methods described below are merely exemplary and may include fewer or more steps, steps may occur at different times, etc.

FIGS. 3A and 3B are a flow chart of a method 300 for identifying and indexing audio tracks, according to an embodiment of the invention. The method 300 for identifying and indexing audio tracks is undertaken mostly by the identifying and indexing procedures 218 (FIG. 2) and the fingerprinting procedures 220 (FIG. 2). At any time, such as before or after a disc has been recorded, a user may insert a disc into the client computer's disk drive 206. The identifying and indexing procedures 218 are then run, either by the user or automatically, which starts the method for identifying and indexing audio tracks, at step 302. The user then indicates a desire to identify and index the music tracks on the disc, at step 304, such as by clicking a button on a Graphical User Interface (GUI), or the like.

The identifying and indexing procedures 218 (FIG. 2) then query the operating system 214 (FIG. 2), at step 306, to ascertain if a disc is in the disc drive 206 (FIG. 2). If a disc is not in the disc drive 206 (FIG. 2) (306—No), then the user is instructed to insert a disc to be identified and indexed into the disc drive, at step 308. The process steps 306-308 are repeated until a disc is detected (or the method is canceled, which may occur at any time (not shown)).

Once a disc is detected in the disc drive 206 (FIG. 2) (306—Yes), the identifying and indexing procedures 218 (FIG. 2) determine whether there are any audio tracks on the disc, at step 310. This is accomplished by determining what file system exists on the discs and then reviewing the file extensions for each file. For example, if the file system is RAW and all the files have a .cda (Compact Disc Audio Track) extension, then it is determined that the CD is an audio CD. Similarly, if the file system contains a mix of files, but includes audio files, such as MP3 or WMA, then it determined that the CD can be labeled as either an audio CD or a data CD. Audio tracks may be raw data, compressed data (such as MP3 or WMA), or the like. If there are no audio tracks on the disc (310—No), then the user is presented with a list of the data files, which the user can then add to, edit, and/or verify, at step 340. A final index of the data files is created, at step 342, and the index printed on the printer 110 (FIG. 1) and/or stored in memory, at step 344, thereby completing the process, at step 346. In a preferred embodiment, the index is printed as a label that can be adhered to the upper surface of the disc. In an alternative embodiment, instructions to print the index may be sent to a remote printer, a service that prints high quality labels, or the like.

However, if there are audio tracks on the disc (310—Yes), then the identifying and indexing procedures 218 (FIG. 2) determine, at step 314, whether the user would nevertheless like to identify the disc as a data disc. If the user indicates a desire to identify the disc as a data disc (314—Yes), then the method is completed as if the disc contained only data, as described above in relation to steps 340-346. If, however, the user does not indicate a desire to identify the disc as a data disc (314—No), then the identifying and indexing procedures 218 (FIG. 2) determine, at step 316, whether any of the audio tracks have any audio identification data associated with them, such as metadata, ID3 tags, or the like.

If the audio track has associated audio identification data (316—Yes), then the identifying and indexing procedures 218 (FIG. 2) determine, at step 332, whether the user is satisfied with the associated audio identification data. The associated audio identification data typically include the audio track's title, album name, song name, length of song, etc. If the user is satisfied with the associated audio identification data (332—Yes), then the user is presented with a list of the audio tracks and their associated audio identification data, which the user can then add to, edit, and/or verify, at step 340. A final index of the data files is created, at step 342, and the index printed on the printer 110 (FIG. 1) and/or stored in memory, at step 344, thereby completing the process, at step 346. In a preferred embodiment, the index is printed as a label that can be adhered to the upper surface of the disc. In an alternative embodiment, instructions to print the index may be sent to a remote printer, a service that prints high quality labels, or the like.

If, however, the user is not satisfied with the associated audio identification data (332—No), then the identifying and indexing procedures 218 (FIG. 2) determine, at step 334, whether the user would like to import a playlist of audio identification data. If the user would like to import a playlist (334—Yes), then a playlist of audio identification data is imported, at step 336. If the user does not want to import a playlist (334—No), or once the playlist has been imported, at step 336, it is determined, at step 338, whether the user would like to retry the identification. If the user does not want to retry the identification (338—No), then the user is presented with a list of the data files, which the user can then add to, edit, and/or verify, at step 340. A final index of the data files is created, at step 342, and the index printed on the printer 110 (FIG. 1) and/or stored in memory, at step 344, thereby completing the process, at step 346. In a preferred embodiment, the index is printed as a label that can be adhered to the upper surface of the disc. In an alternative embodiment, instructions to print the index may be sent to a remote printer, a service that prints high quality labels, or the like.

Now, if the audio track does not have associated audio identification data (316—No), or if the user wants to retry the identification (338—Yes), then the identifying and indexing procedures 218 (FIG. 2) start a recognition procedure, at step 320. The communication procedures 216 (FIG. 2) then determine, at step 322, whether there is a connection to the network 106 (FIG. 1), such as a connection to the Internet. If there is not a connection to the network (322—No), then the user is informed that there is no connection to the network, at step 324, and it is determined, at step 332, whether the user is satisfied with the associated audio identification data, etc, as described above in relation to steps 332-340.

If there is a connection to the network (322—Yes), then the searching procedures 226 (FIG. 2) perform, at step 326, a database lookup to identify the audio track. This database lookup is performed by searching a CD identification service, such as FreeDB or CDDB (CD database from GRACENOTE), which obtains the audio identification data for each audio track on a commercial CD via the Internet. For example, to obtain audio identification data, a user inserts a commercial CD into the computer's CD drive. Client software on the computer uses the number of tracks, the total length of the CD, and the length and sequence of each audio track (obtained from the CD's table of contents) to obtain a unique CD identifier for the commercial CD. Using this unique CD identifier, the client software queries a remote database coupled to the Internet, which returns audio identification data for the commercial CD to the client software. Such audio identification data typically includes the artist, CD-title, and tracklist.

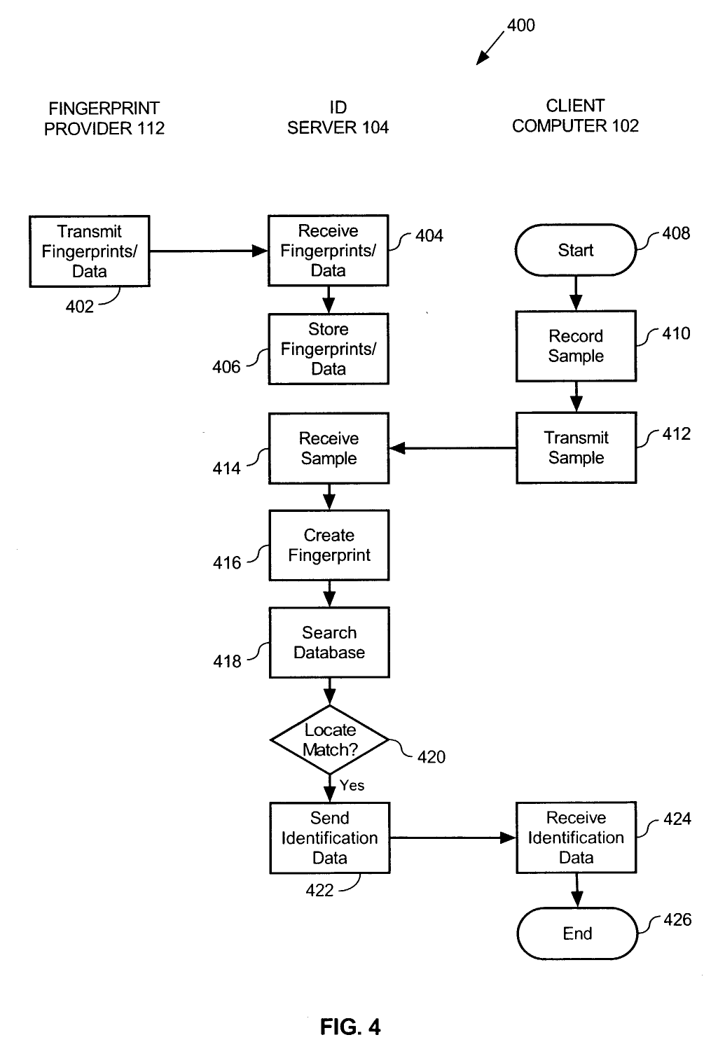

The identifying and indexing procedures 218 (FIG. 2) subsequently determine whether the database lookup was successful, at step 328. If the database lookup was successful (328—Yes), then it is determined, at step 332, whether the user is satisfied with the associated audio identification data, etc. If the database lookup was not successful (328—No), then fingerprinting is performed on each unidentified audio track, at step 330. The methods for performing fingerprinting are described in further detail below in relation to FIGS. 4-6. In an alternative embodiment, connection to the network 106 (FIG. 1) may be automatically established by the communication procedures 216 (FIG. 2) after step 320.

After fingerprinting has been performed, the communication procedures return audio identification data for each audio track recognized or identified. The identifying and indexing procedures 218 (FIG. 2) then determine, at step 332, etc, as described above in relation to steps 332-340.

FIGS. 4-6 describe three exemplary methods for performing fingerprinting, as per step 324 of FIGS. 3A and 3B. Each of these exemplary methods for performing fingerprinting will now be described.

FIG. 4 is a flow chart of a method 400 for performing audio fingerprinting, according to an embodiment of the invention. Audio fingerprinting identifies audio tracks by comparing a unique audio identifier or fingerprint of a sample of an audio track to a database of known fingerprints associated with known audio tracks. One suitable audio fingerprinting technique is described in AUDIBLE MAGIC CORP's U.S. Pat. No. 5,918,223, which is incorporated herein by reference. Other suitable audio fingerprinting technology is available from AUDITUDE of Los Angeles, Calif.

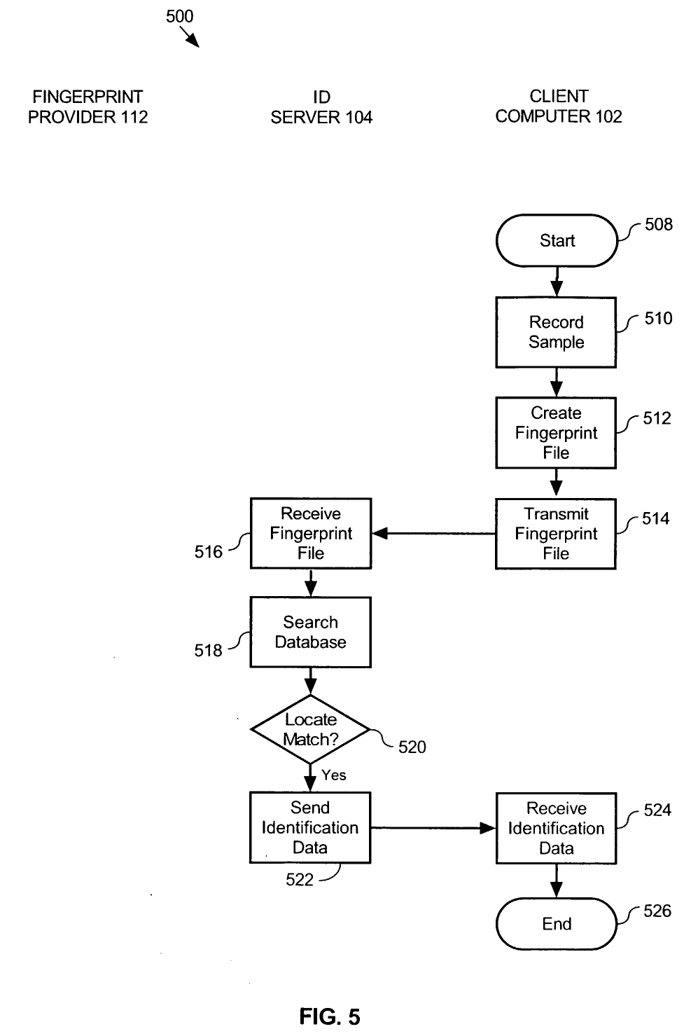

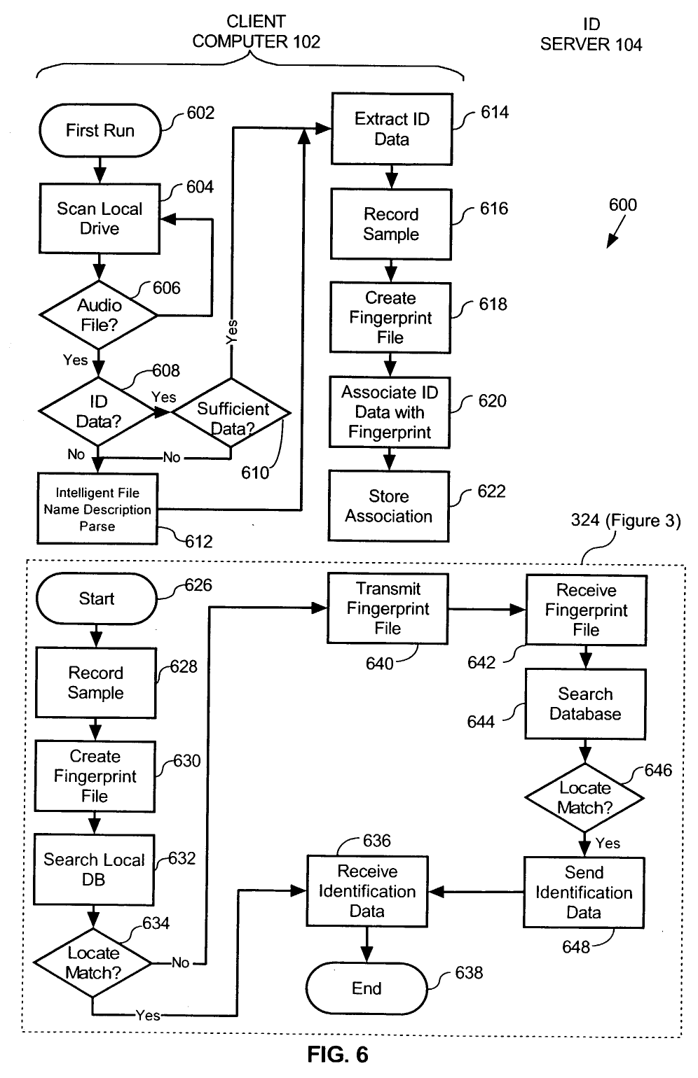

In a preferred embodiment, the fingerprint provider 112 (FIG. 1), periodically transmits fingerprints and associated identification data to the identification server 104 (FIG. 1), at step 402. Such fingerprints and associated identification data is received by the identification server, at step 404, and stored in a database on the identification server 104, at step 406. Steps 402 to 406 apply equally well to FIGS. 5 and 6.

Method 400 is started, at step 408, and a sample recorded of each audio track by the recording procedures 224 (FIG. 2), at step 410. Each sample is preferably 10 to 30 seconds long and stored as a WAV file in cache 234 (FIG. 2). The sample is then transmitted, at step 412, to the identification server 104 (FIG. 1). The identification server receives the sample, at step 414, and creates an audio fingerprint of the sample, at step 416. A database is searched, at step 418, for a match to the audio fingerprint. If a match is located (420—Yes), then identification data associated with the located matched fingerprint is sent to the client computer 102 (FIG. 1), at step 422. The client computer then receives the audio identification data, at step 424, and the fingerprinting method is completed, at step 426. The received audio identification data is then used to create an index, as per step 332 of FIGS. 3A and 3B.

FIG. 5 is a flow chart of another method 500 for performing fingerprinting, according to another embodiment of the invention. Method 500 is started, at step 508, and a sample recorded of each audio track, at step 510, by the recording procedures 224 (FIG. 2). The fingerprint creation procedures 222 (FIG. 2) then create an audio fingerprint for each sample, at step 512. Each sample is preferably 10 to 30 seconds long and stored as a WAV file in cache 234 (FIG. 2). The fingerprint is then transmitted, at step 514, to the identification server 104 (FIG. 1). The identification server then receives the fingerprint, at step 516, and a database is searched, at step 518, for a match to the received fingerprint. If a match is located (520—Yes), then identification data associated with the located matched fingerprint is sent to the client computer 102 (FIG. 1), at step 522. The client computer then receives the identification data, at step 524, and the fingerprinting method is completed, at step 526. The received audio identification data is then used to create an index, as per step 332 of FIGS. 3A and 3B.

Admittedly, in practice it is currently difficult to compile a complete list of all audio tracks from a single source using fingerprinting. In addition, performing fingerprinting from a remote database is time consuming, at approximately 10-15 seconds per audio track. Furthermore, running an ID server 104 (FIG. 1) that serves fingerprints for numerous users, is costly—having an associated cost per audio track identification. Therefore, a method for either assisting the fingerprinting process 324 (FIGS. 3A and 3B) as described in FIGS. 4 and 5, or reducing the dependence on the remote ID server 104 (FIG. 1) is preferred. Such a method for performing the fingerprinting process 324 (FIGS. 3A and 3B) while reducing the dependence on the remote ID server 104 (FIG. 1) will now be described.

FIG. 6 is a flow chart of yet another method 600 for performing the fingerprinting process 324 (FIGS. 3A and 3B), according to yet another embodiment of the invention. This method 600 utilizes the user's local collection of audio files to generate audio fingerprints for each located audio file. These local fingerprints are associated with audio identification data that are stored together with the original audio files. Unidentified audio tracks on a disc are then checked against the user's local fingerprints for a match. Such a method, therefore, reduces the dependency on a remote ID server by first checking a local database of fingerprints. This method is particularly useful for users that record the same CDs more than once, i.e., to replace those that are lost, etc., or for users that record CDs from their own collections, which are typically stored on their local hard drives.

In a preferred embodiment, when the identification and indexing method is first run, at step 602, the searching procedures 226 (FIG. 2) scan the client computer's memory 212 (FIG. 2), at step 604, for any audio files, such as WAV, MP3, WMA, RA, or the like files. In an alternative embodiment, such a scan (step 604) is performed each time the identification and indexing procedures 218 (FIG. 2) are invoked, although this would be time consuming. It should also be appreciated that if the original audio file is moved the application can rescan the hard drive and associated files to determine where the file has been moved to.

Once an audio file is located (606—Yes), the identifying and indexing procedures 218 (FIG. 2) then determine, at step 608, whether any of the audio files have associated audio identification data, such as metadata, ID3 tags, or the like. If the audio track has associated identification data, at step 608—Yes, then the identifying and indexing procedures 218 (FIG. 2) determine, at step 610, whether such associated identification data includes all required identification fields, i.e., whether the associated audio identification data is 100% recognized. The required identification fields are those fields typically required by the user in the index, such as title, album name, song name, length of song, etc.

If the associated identification data does not include all required identification fields, (610—No), then the identifying and indexing procedures 218 (FIG. 2) parse whatever information is available from the audio file, such as any ID3 data, file name, etc., to assist in fingerprint identification. If the associated identification data does include all required identification fields (610—Yes), or once any available information is parsed, at step 612, then any identification information is extracted from the audio file, at step 614. A sample of the audio file is then recorded, at step 616, and a fingerprint created from the sample, at step 618. The extracted audio identification data is then associated with the fingerprint, at step 620, and this association stored in the local database of fingerprints and associated audio identification data 228 (FIG. 2), at step 622.

To perform fingerprinting, as per step 324 of FIGS. 3A and 3B, the method 600 is started, at step 626, and a sample recorded of each audio track to be identified, at step 628, by the recording procedures 224 (FIG. 2). The fingerprint creation procedures 222 (FIG. 2) then create an audio fingerprint for each sample, at step 630. Each sample is preferably 10 to 30 seconds long and stored as a WAV file in cache 234 (FIG. 2). The searching procedures 226 (FIG. 2) then search the local database of fingerprints and associated audio identification data 228 (FIG. 2), at step 632. If a match between the created fingerprint and a fingerprint in the local database of fingerprints and data is located (634—Yes), the identification data associated with the stored fingerprint is received, at step 636, and the fingerprinting method is completed, at step 638.

If, however, a match between the created fingerprint and a fingerprint in the local database of fingerprints and data is not located (step 634—No), then the created fingerprint is transmitted, at step 640, to the identification server 104 (FIG. 1), by the communication procedures 216 (FIG. 2). The identification server then receives the fingerprint, at step 642, and a remote database on the identification server is searched, at step 644, for a match to the received fingerprint. If a match is located (step 646—Yes), then identification data associated with the located matched fingerprint is sent to the client computer 102 (FIG. 1), at step 648. The client computer then receives the identification data, at step 636, and the fingerprinting method is completed, at step 638. The received audio identification data is then used to create an index, as per step 332 of FIGS. 3A and 3B.

In an alternative embodiment, the database of fingerprints and associated audio data 228 (FIG. 2) can store additional information, such as the location of each of a user's audio files. This is particularly useful if the user wants to create not just an index for a single disc, but rather an index for their entire audio collection by location. For example, a user may print an index of all audio tracks on discs within a particular storage case or multiple disc changer. Locations of each audio track may also include locations on a particular server or at a particular Internet address. Moreover, this index may be used by a central audio server, such as SONICBLUE's RIO CENTRAL digital audio center to playback audio tracks from various components coupled to a local network. In addition, this method can be used to track both physical CDs and physical locations of songs, thereby providing multiple ways for finding music.

In the case of a storage case or a multiple disc changer, the software could print out a larger index meant to fit the storage case. As the database is stored on the client computer, it can be accessed via a variety of means including keyword search, etc. In other words, if a user wanted to determine the whereabouts of a disc containing a certain song, the user could type in that song name and the database would return the location of the disc containing that song, such as in the car changer, a home storage case, loaned to a friend, etc. By knowing where each audio track is located, the process of replacing a lost or misplaced disc is easily and transparently facilitated.

Still further, the database of fingerprints and associated audio identification data 228 (FIG. 2) may also include formatting information as well as the artwork that was used to create an original label. Such formatting information and artwork may also be associated with each audio track, so that transfer of the audio track includes transfer of the formatting and artwork. This may be accomplished by associating an image or label with each audio file, or using ID3V2, the CD cover image could be integrated into the native MP3 file. If the label artwork and formatting, as well as the file location are stored, then it should be appreciated that reproducing a lost burned disc could be easily achieved, without the user having to know the location of each audio track. For example, a single button could be selected to re-record a disc, and another could be selected to re-print the label. One skilled in the art would appreciate that this requires some simple integration with the recording software, either by outputting the disc contents as a playlist or through more direct integration with the recording software.

It should also be appreciated that database functionality is also useful for data file applications (and not just audio files). For example, a user might want to know the contents or location of a recorded data disc. Because the software associates the contents of the file with a location on the local machine, it would be possible to see not just the file name and size of the file that was burned on a disc, but also (assuming the file still exists on the local machine) it would be possible to actually open the local copy of that file.

In conclusion, all the user has to do to initiate population of a database of fingerprints and associated audio identification data is simply put a disc in the client computer's disc drive while the method of identifying and indexing is running. The method automatically determines the type of information on the disc (data files, WAV audio, etc.) and identifies the files and populates the label (and concurrently the database) with the audio (or data file) information. In addition, upon printing out the label, the software preferably automatically populates the database with the date and time the disc was burned with no additional intervention from the user. If the user wishes to further categorize the location of the disc or to whom it was sent, the user may manually add such information. The user can also add the physical location of the disc, such as in the disc changer in the house, etc.

In an alternative embodiment, a personalized ranking indicating how much a user likes a song may be associated with each song. Also in an alternative embodiment, the user may have the ability to store multiple labels for a single CD.

The foregoing descriptions of specific embodiments of the present invention are presented for purposes of illustration and description. They are not intended to be exhaustive or to limit the invention to the precise forms disclosed. Obviously many modifications and variations are possible in view of the above teachings. For example, any of the aforementioned embodiments or methods, may be combined with one another, especially if a combination of embodiments or methods can be used to assist in the identification of an audio track. The embodiments were chosen and described in order to best explain the principles of the invention and its practical applications, to thereby enable others skilled in the art to best utilize the invention and various embodiments with various modifications as are suited to the particular use contemplated. Furthermore, the order of steps in the method are not necessarily intended to occur in the sequence laid out. It is intended that the scope of the invention be defined by the following claims and their equivalents.

What is claimed is:

1. A method for creating an audio index, comprising:
determining that a computer disc contains at least one audio track;
obtaining audio identification data associated with said at least one audio track using digital fingerprinting; and
creating an index based on said audio identification data.

2. The method of claim 1, further comprising, before said determining, receiving an instruction to create said index.

3. The method of claim 1, further comprising, before said obtaining, determining that sufficient audio identification data associated with each audio track does not exist to create and audio track index without using digital fingerprinting.

4. The method of claim 1, wherein said obtaining comprises:
recording a sample of said at least one audio track;
transmitting said sample to a remote identification server for identification using digital fingerprinting; and
receiving said audio identification data from said remote identification server, where said remote identification server identifies said at least one audio track based on said sample.

5. The method of claim 1, wherein said obtaining comprises:
recording a sample of said at least one audio track;
creating a unique digital fingerprint of said at least one audio track using said sample;
transmitting said digital fingerprint to a remote identification server for identification using digital fingerprinting; and
receiving said audio identification data from said remote identification server based on said digital fingerprint.

6. The method of claim 1, wherein said obtaining comprises:
recording a sample of said at least one audio track;
creating a unique digital fingerprint of said at least one audio track using said sample;
searching a local database for a match to said digital fingerprint;
receiving said audio identification data based on said digital fingerprint.

7. The method of claim 6, further comprising, before said receiving, transmitting said digital fingerprint to a remote identification server for identification using digital fingerprinting, if a match to said digital fingerprint could not be made on said local database.

8. The method of claim 6, further comprising, before said recording:
scanning a local drive for audio files;
determining whether said audio files include associated audio identification data;
extracting said audio identification data from each located audio file;
recording a sample of each located audio file;
creating a unique digital fingerprint for each located audio file using said sample;
establishing an association between said audio identification data and said digital fingerprint for each located audio file; and
storing said association for each located audio file.

9. The method of claim 1, further comprising printing said index.

10. The method of claim 1, further comprising printing a disc label based on said index.

11. The method of claim 1, further comprising storing said index.

12. The method of claim 1, further comprising, after said determining, ascertaining that said computer disc is not to be identified as a data disc.

13. The method of claim 1, further comprising, prior to said obtaining, unsuccessfully performing a database lookup to obtain said audio identification data.

14. The method of claim 1, further comprising, after said obtaining, importing a playlist containing audio identification data.

15. The method of claim 1, further comprising, after said obtaining, allowing a user to add, edit, or verify said audio identification data.

16. A system for creating an audio index, comprising:
a client computer comprising:
a central processing unit;
communication circuitry;
a disc drive;
a memory having:
identifying and indexing procedures for:
determining that a computer disc contains at least one audio track;
obtaining audio identification data associated with said at least one audio track using digital fingerprinting; and
creating an index based on said audio identification data.

17. The system of claims 16, further comprising a printer coupled to said client computer, and configured to print a computer disc label of said index.

18. The system of claims 16, further comprising an identification server configured to supply said audio identification data by performing digital fingerprinting of audio tracks contained on said computer disc.

19. The system of claims 18, further comprising a network coupling said identification server to said client computer.

20. The system of claims 19, further comprising a fingerprint provider coupled to said network, where said fingerprint provider is configured to supply fingerprints of known audio tracks to said identification server.
